(19) United States
(12) Patent Application Publication
(10) Pub. No.: US 2012/0197976 A1
(43) Pub. Date: Aug. 2, 2012

(54) SYSTEM AND METHOD FOR OBTAINING CONTACTS FROM SOCIAL NETWORKS AND EMAIL SYSTEMS

(76) Inventors: Bharat Welingkar, Los Altos, CA (US); Jiji Nair, Santa Clara, CA (US); Kyle Tran, San Jose, CA (US)

(21) Appl. No.: 13/252,968

(22) Filed: Oct. 4, 2011

Related U.S. Application Data
(60) Provisional application No. 61/406,969, filed on Oct. 26, 2010.

(51) Int. Cl. G06F 15/16

(52) U.S. Cl. 709/203

(57) ABSTRACT

A cloud based data service provides a mobile device ability to define one or more sources of contact data and fetch a set of composite contacts populated in the cloud. The cloud based service automatically aggregates one or more “similar” contacts into a “composite” contact.

### CROSS REFERENCE TO RELATED APPLICATION

This application claims benefit under 35 U.S.C. §119(e) from U.S. Provisional Patent application No. 61/406,969, filed on Oct. 26, 2010, the entirety of which is incorporated by reference herein.

### FIELD OF THE INVENTION

The present invention generally relates to systems and methods for organizing a user's address book contacts, and more particularly to systems and methods for organizing address book contacts on a mobile computing device and populating the address book.

### SUMMARY OF THE INVENTION

A cloud based data service provides a mobile device the ability to define one or more sources of contact data and fetch a set of composite contacts populated in the cloud. The cloud based service automatically aggregates one or more “similar” contacts into a “composite” contact.

Many mobile devices provide the ability to set up contact providers within a contact manager application, which in turn handles all the synchronization of contacts and merge, de-duplication on the device itself. This is an expensive effort if performed on the constrained device. The system and method of the present invention pushes the unit of work (fetching and merging of contacts from one or more contact providers) to the cloud and thereby removes the burden from the device. Additionally, since the work is done in the cloud, it is easier to extend the functionality without having to change the software on the device.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a block diagram of a system for storing and combining one or more contacts from one or more contact providers, according to an exemplary embodiment;

FIG. 2 illustrates the sequence for adding an external social network;

FIG. 3 depicts the process for removing a network from the list of networks in the contacts in the cloud;

FIG. 4 depicts the process for merging contacts from his/her contacts in the cloud;

FIG. 5 illustrates the process for synchronizing the user's contact list with external networks (e.g., social networks);

FIG. 6A-6C depict user interface (UI) screens illustrating the addition of new contact to a user's contact list;

FIGS. 7A-7C depict the (UI) screens illustrating the filtering of a user's contact list by the source of the contact (e.g., from the user's Google contact list);

FIGS. 8A-8B depict the (UI) screens illustrating the filtering of a user's contact list by groups; and

FIGS. 9A-9B depict the (UI) screens illustrating a process of importing a user's contacts from social networks.

### DETAILED DESCRIPTION OF THE INVENTION

A system and method of maintaining an address book for a handheld computer or other mobile devices in a shared, scalable computing resource is described. The method includes receiving a request to setup contact provider data from the handheld computer at the shared, scalable computing resource. The request is received via a secure wireless communication protocol having authentication of an identity of the handheld computer. The method includes fetching and storing the address book data on the shared, scalable computing resource as a part of overall system. The method further includes fetching the combined data from the same or a second computing device.

As used herein, the “cloud” or “cloud computing” provides computation, software, data access, and storage services that do not require end-user knowledge of the physical location and configuration of the system that delivers the services. Parallels to this concept can be drawn with the electricity grid, wherein end-users consume power without needing to understand the component devices or infrastructure required to provide the service.

Cloud computing is delivery model for information technology services based on Internet protocols, and it typically involves provisioning of dynamically scalable and often virtualized resources. It is a byproduct and consequence of the ease-of-access to remote computing sites provided by the Internet. This may take the form of web-based tools or applications that users can access and use through a web browser as if the programs were installed locally on their own computers.

Cloud computing delivers applications via the internet or other communication channels, which are accessed from a web browser, while the software and data are stored on servers at consolidated or distributed remote locations. Most cloud computing infrastructures consist of services delivered through shared data-centers and appear as a single point of access for consumers' computing needs.

The present invention allows mobile device users to have a consolidated view of their contacts across various networks, including social networks such as Facebook™, Google™, etc. This consolidated contact view of a user's contacts is considered to be a critical building block for offering other community-related features such as sharing, lending, and social-review. The process of gathering, syncing, and aggregating the users' contact data is preferably performed periodically by back-end components, and persisted in a cloud. This data is made available to the device(s) by exposing Web Service end-points deployed in the cloud services layers.

The system of the present invention provides an infrastructure that is deployed in the cloud and allows the user to access the users' contact data from multiple networks. The system supports the periodic syncing, aggregation, and persistence of the users' contacts data in the cloud, to be made available to the users' devices on demand. The system enables the syncing interval to be configurable across networks, so that social data from different networks can be synced at different frequencies.

The Address Book in the Cloud (ABC) system of the present invention is embodied in the cloud and is used by the software stack of the registered mobile device of users to enhance applications with social networking capabilities. At a higher-level, this service enables the device user to fetch his/her contacts information from various social networks such as Google™, LinkedIn™, Facebook™, etc., and persist the contacts data in a merged format in the cloud. Any updates that happen on the networks for the user's contacts data are synced automatically by the service, and made available for the device user periodically through notification, and on demand.

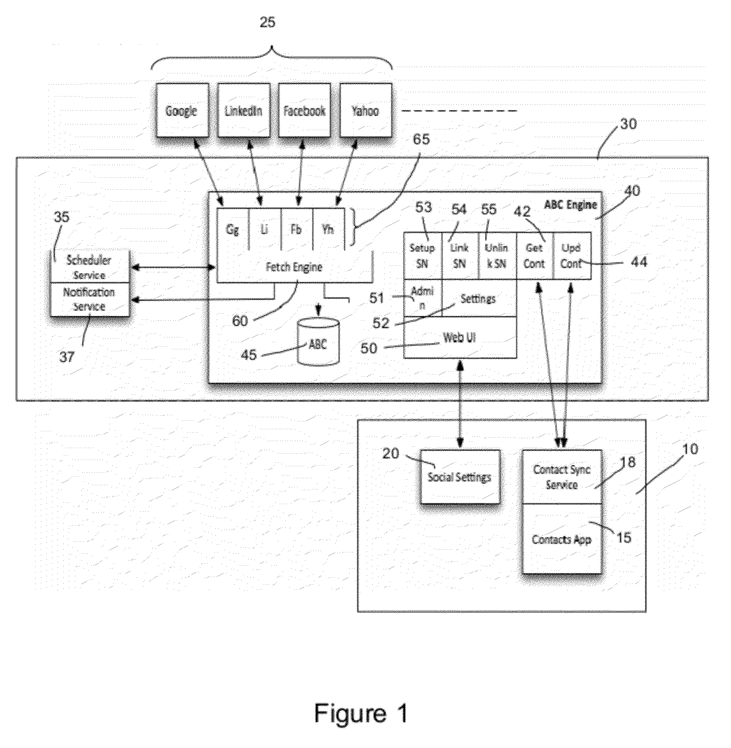

FIG. 1 illustrates a system according to the present invention. On the user's mobile device 10 there are software and databases 15 for maintaining and controlling the user's contacts (address book) and software and databases 20 for maintaining and controlling the user's links and interactions with the user's accounts on various social networks 25. The user's device 10 connects to the cloud portion 30 of the system via traditional methods such as through the Internet or telephone (e.g., cell phone) networks. The cloud portion 30 of the system is constructed of one or more servers at a central location or at distributed locations.

An Address Book in the Cloud (ABC) engine and databases 40 reside on the server(s) in the cloud system 30. The ABC engine 40 includes an interface 50, preferably a web interface, for communicating with the user's device 10 and for performing services requested by the user via her device 10. The ABC engine 40 also include a Fetch engine 60 that employs interfaces 65 for interfacing with the various social networks 25 (e.g., Facebook™, LinkedIn™ . . . ). As further described below, some of these services with respect to the social networks 25 include fetching and synchronizing information about the user's contacts. This information is merged and updated in the ABC database 45, which can reside in a user's digital locker on the cloud servers. The user's digital locker contains all of the user's information relative to the system (e.g., books he owns, preferences, contacts . . . ).

As further described below in regard to the use cases, the ABC Engine 40, through the interface 50, provides the following services to the user through a social settings application 20 on the user's device 10: Administration 51, Settings 52, Setup 53, Link 54 and Unlink 55. Further, the ABC Engine 40 also provides the services to get a user's contacts 42 and update a user's contacts 44. These services do not require the user interface 50. These services communicate with a Contact Sync application 18 on the user's device 10, which is controlled by the Contact Application 15, also on the user' device 10.

The ABC Engine 40 supports the following three major use cases:

Add/Remove networks: The user can add or remove a social network 25 from his ABC configuration using the Link 54 and Unlink 55 functions in the ABC Engine 40. The addition of a network 25 for contacts data aggregation requires network-level authorization by the user to access his data on the particular social network 25. That is to say, the user must provide the ABC Engine 40 with the credentials (e.g., user ID and password) to enable the ABC Engine to access the social network 25 on the user's behalf. Once a social network 25 is added, the ABC Engine 40 automatically and periodically synchronizes the contacts data at a predefined interval that can be set by the user. The synchronization can be either one way or two ways, i.e., the ABC Engine 40 can update its ABC database 45 with new contacts or changed contacts that it finds on a social network 25, and it can also update the contacts on the social network 25 with the new contacts or changed contacts that exist in its database 45.

Fetch Contacts: Using the Contacts application 15 resident on the user's device 10, the user can request a list of his contacts. Optionally the user can specify some filter criteria such as a particular network 25, the name of a particular contact, etc. These fetch requests are handled by the Get Contacts service 42 and the Fetch Engine 60 in the ABC Engine 40.

Scheduled Synching: A backend component, Scheduler Service 25, is operable with the Fetch Engine 60 in the ABC Engine 40 to manage the synching of the user' contacts at specified intervals. The synching frequency is specific to the particular network 25 and is configurable by the user. The Notification Service 37 provides the user with notifications when new or updated contacts have been added or changed in the user's contact list.

The three use cases described above are architecturally significant and, in part, determine the structure and relationships of the major elements of the ABC Engine 40. Extensions to these use cases are possible, and can be addressed with minor changes to the ABC Engine 40 elements. The sections below describe the sequences corresponding to each of these use cases between high-level components that participate in them.

Use-Case—Add Network

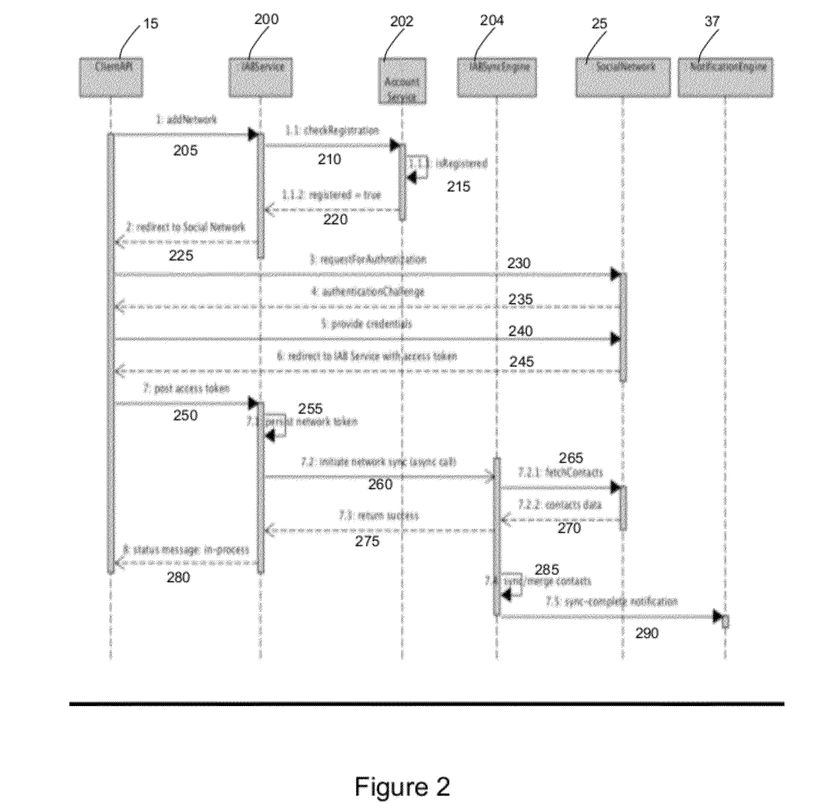

In this use case, the device user is interested in adding an external social network 25 to his ABC configuration. FIG. 2 illustrates the sequence for adding an external social network 25. The user starts the ABC client application 15 on her device 10 and selects an ‘Add Social Network’ menu option. From a list of supported social networks (e.g., Google™, Facebook™, LinkedIn™, etc.), she picks one and clicks ‘Add’. The ABC client application 15 makes the ‘add network’ request 200 to the ABC Engine 40 in the cloud. The ABC Sync service 200 receives the ‘add network’ request and begins processing the request.

If the user is a registered user, the ABC service 200 redirects 210 the user to the network authorization web/mobile page from Account Services 202 where the user can enter his network credentials. On successful authentication 215, the Account Services 202 authorizes the cloud to access the user's contacts data on the network by issuing a special access token. The ABC Service 200 then places an asynchronous request for network addition to the ABC Sync Engine 204. The request status is marked ‘in-process’ and a corresponding response 220, 225 is communicated to the device 10. The response 225 redirects the ABC client application 15 to the social network 25 to be added.

If the user is not registered, the ABC service 200 is not able to recognize the device 10 as belonging to a valid customer ID. In this case, the request status is marked ‘warning’ and a response with a message prompting the user to register the device is communicated to the device.

Upon receipt of the response 225, the ABC client application 15 contacts the social network 25 and requests authorization 230. The social network 25 then requests 235 the user's credentials, e.g., user ID and password. In response, the ABC client application 15 provides 240 the credentials that had been supplied by the user. Once the user is authenticated on the social network 25, the social network responds 245 with an access token for use on the social network 25. The ABC client application 15 posts 250 the social network access token to the ABC service 200, which persists 255 the access token in the cloud.

With the token in hand, the ABC service 200 autonomously contacts 260 the ABC Sync Engine 204 to initiate the contact sync process with the social network 25. This contact with the social network 25 is autonomous because it is the ABC Sync Engine 204 in the cloud 30 that is logging onto the social network 25, not the user. The ABC Sync Engine 204, on receiving the ‘add network’ message for a specific social network makes API calls 265, on behalf of the user, to fetch the contacts data. The social network 25 returns 270 with the user's contact data found on the social network 25. The ABC Sync Engine 204 informs 275 the ABC service 200 that the contacts were successfully retrieved and the ABC service 200 informs 280 the ABC client application 15 that the sync process is in progress. The list of contacts are synched and then merged 285 with other contacts data persisted on the cloud by ABC Sync Engine 204. Once the sync and merge process is completed, ABC Sync Engine 204 contacts 290 Notification Engine 37, which informs the user that the process is completed.

Use-Case—Remove Network

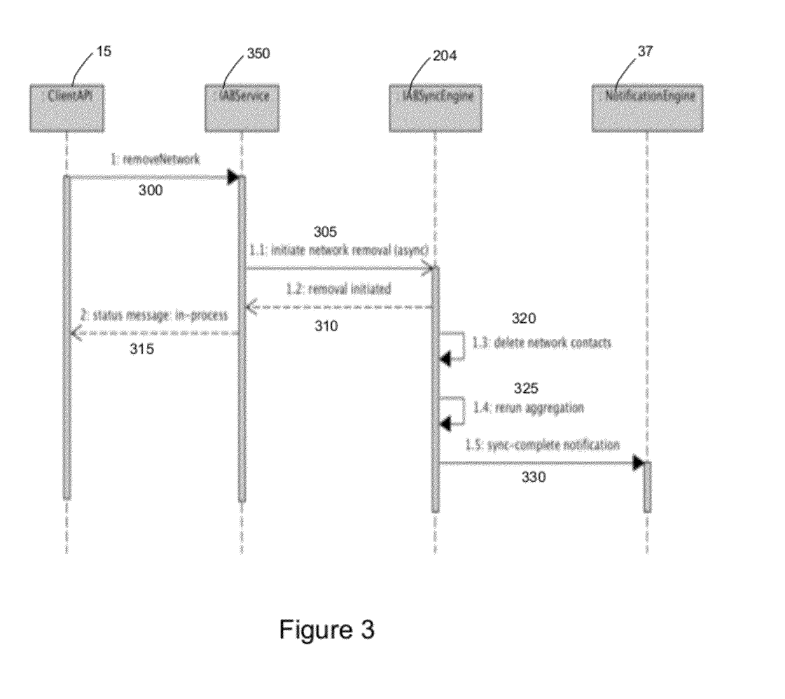

In the process illustrated in FIG. 3, the device user wants to remove a network 25 from the list of networks 25 in her ABC configuration on the cloud 30.

The user starts the ABC client application 15 on the device 10 and selects a ‘Remove Social Network’ menu option. From a list of supported social networks 25 (e.g., Google™, Facebook™, LinkedIn™, etc.), she picks one and clicks ‘Remove.’ The ABC client application 15 makes the ‘remove network’ request 300 to the ABC Contacts service 350 on the cloud 30.

The ABC Contacts service 350 receives the ‘remove network’ request and places an asynchronous request 305 for network removal to the ABC Sync Engine 204. The request status is marked ‘in-process’ and a corresponding response 310 is communicated 315 to the device 10.

The ABC Sync Engine 204, on receiving the ‘remove network’ message for a specific social network 25 removes 320 from the cloud's database the profiles of the user's contacts that were obtained from the specified network 25. This is followed by a new contacts aggregation 325 from the remaining networks for the user resulting in a new merged contacts list for the user.

On successful aggregation, the ABC Sync Engine 204 places a ‘success’ status message in the queue of the device Notification Engine 37 for delivery to the user.

Use-Case—Fetch Contacts

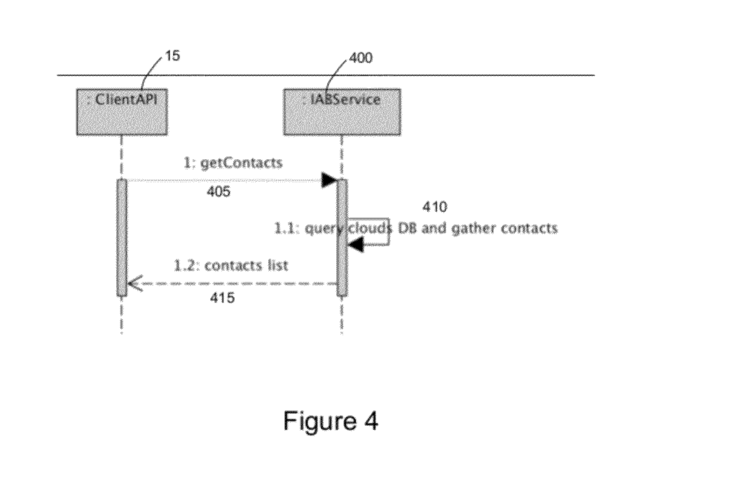

In the process illustrated in FIG. 4, a user makes a request to get merged contacts from his/her ABC configuration on the cloud 30. Optionally he adds additional criteria to filter the results returned from the cloud 30.

The user starts the ABC client application 15 on the device 10 and selects a ‘Get Contacts’ menu option. Optionally the user selects additional criteria such as ‘search by name’, ‘search by network’ etc. The ABC client application 15 makes a ‘get contacts’ request 405 to the ABC Contacts Service 400 on the cloud 30. The ABC Contacts Service 400 receives the request and queries 410 the cloud's database for the registered account corresponding to the device 15. The query returns the list of contacts which is forwarded 415 to the device 10 in the payload protocol specified in the request (e.g., Google Protocol Buffer (GPB) or JavaScript Object Notation (JSON)). The client application 15 is then able to display the list of contacts received from the ABC Contact Service 400.

Use-Case—Scheduled Synching

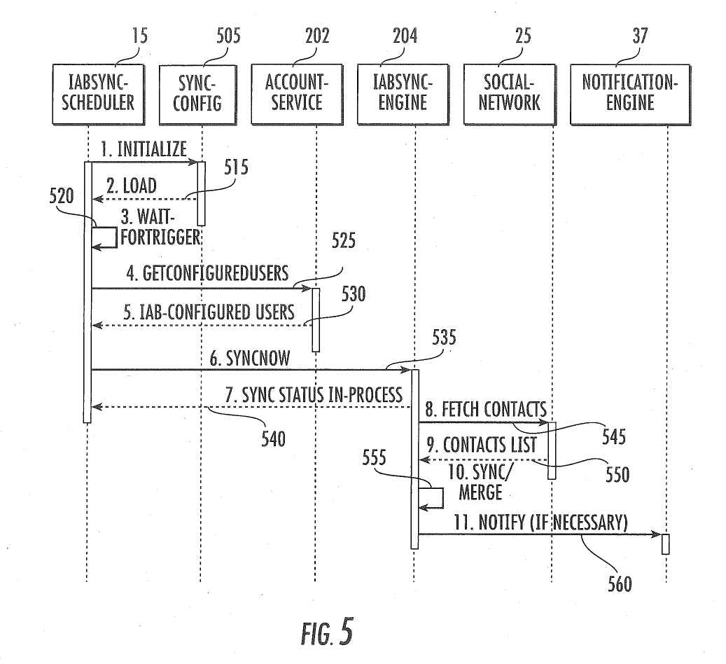

In the process illustrated in FIG. 5, the ABC Scheduler component 500 on the cloud 30 triggers a sync request to the ABC Sync Engine 204 based on the predefined intervals. On completion of synching, the device user gets notified via the notification engine 37.

As an initialization step 510, the ABC Sync Scheduler component 500 loads 515 scheduler configuration data representing the sync-intervals for various networks 25. ABC Sync Scheduler 500 then sets up 520 triggers for running the synch and merge operation. ABC Sync Scheduler 500 then contacts 525 Account Services 202 asking for all users that have an ABC configuration that requires synchronization. Account Services 202 returns 530 the list of configured users to ABC Sync Scheduler 500.

On firing of the trigger, the ABC Sync Scheduler' makes an asynchronous request 535 to the ABC Sync Engine 204. The ABC Sync Scheduler 500 is notified 540 that the process is in progress. For each configured user, the ABC Sync Engine 204 fetches 545, 550 the contacts from all of the networks 25 configured for that user. The ABC Sync Engine 204 identifies deltas (changes), if any, and syncs/merges 555 these changes into the user's contact list in the cloud database. If there have been changes, ABC Sync Engine 204 notifies the device user by placing a message in the notification queue of the Notification Engine 37. If there is no change in the contacts data since the previous synching, there will not be a notification to the device 10.

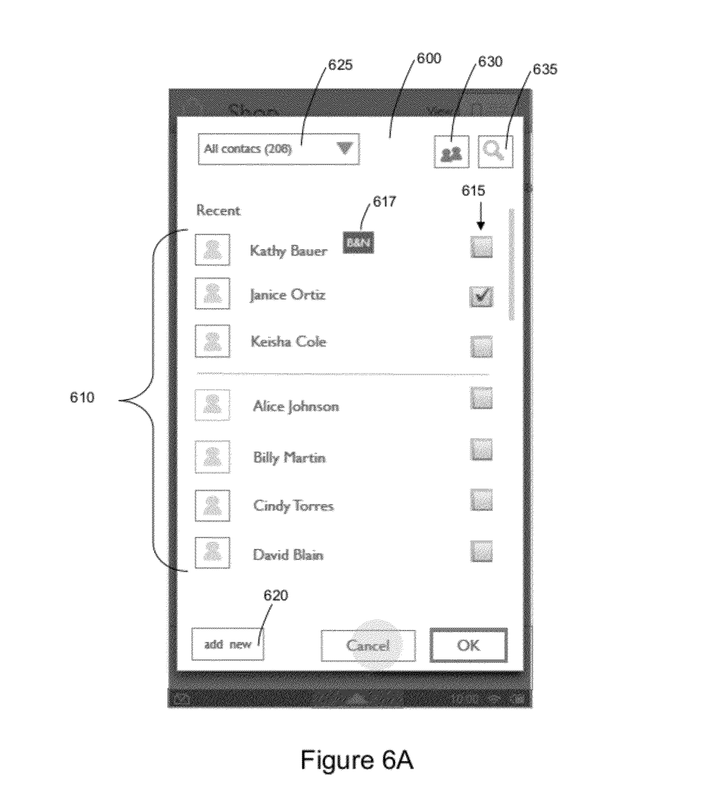

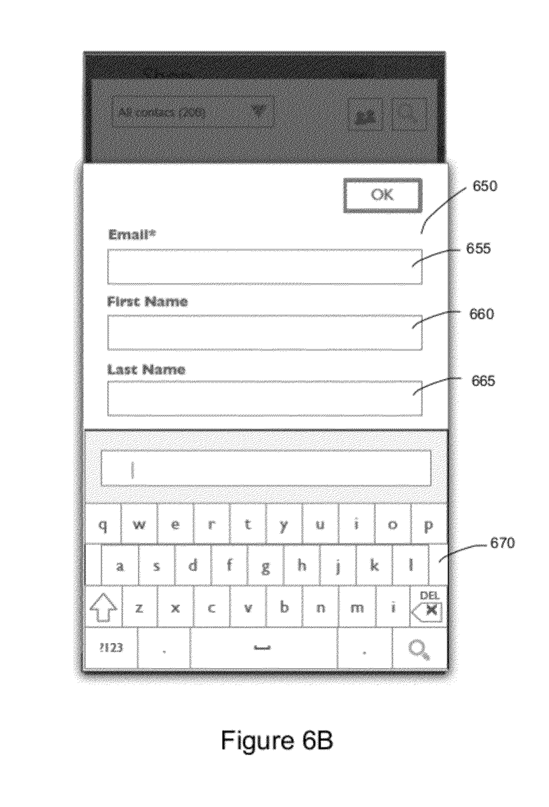

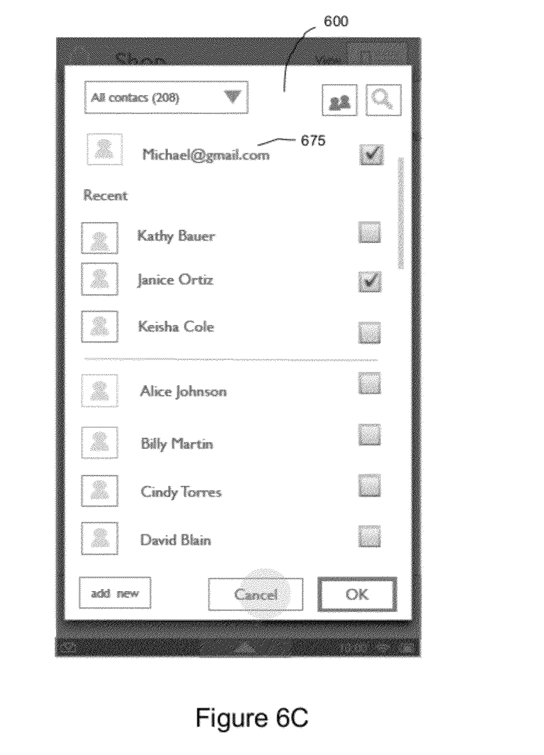

FIGS. 6A-6C depict user interface (UI) screens illustrating the addition of a new contact to a user's contact list. As shown in FIG. 6A, contacts 610 are aggregated from the user's accounts (Facebook™, Gmail™ . . . ) on user interface screen 600. In a preferred embodiment, a contact lookup is performed against registered users of the system and the contact is denoted with an icon (e.g., system logo) 617 in the user's contact list if the contact is a registered user. The user can use dropdown box 625 to filter her contacts according to predefined criteria. The search button 635 can be used to search for specific contacts 610. Button 630 is an icon for the user's groups or friends. Tapping on button 630 will show all the user's contacts that also have accounts on the cloud. The selectors 615 also change (either to a check box or a radial button) depending on the nature of the task. In order to manually add a new contact, the user can tap button 620.

As shown in FIG. 6B, a user can add a new email contact, which starts the add new email flow. New contacts can either be synced back to the respective email accounts or just locally stored. The contacts are prioritized with most recent contacts. When add a new contact is selected, user interface 650 is displayed on the device 10. The user is provided with areas to enter the contact's email address 655, first name 660 and last name 665. A virtual keyboard 670 is automatically exposed. As shown in FIG. 6C, after the new contact has been entered, the new contact 675 is added on top of the “Recent” header.

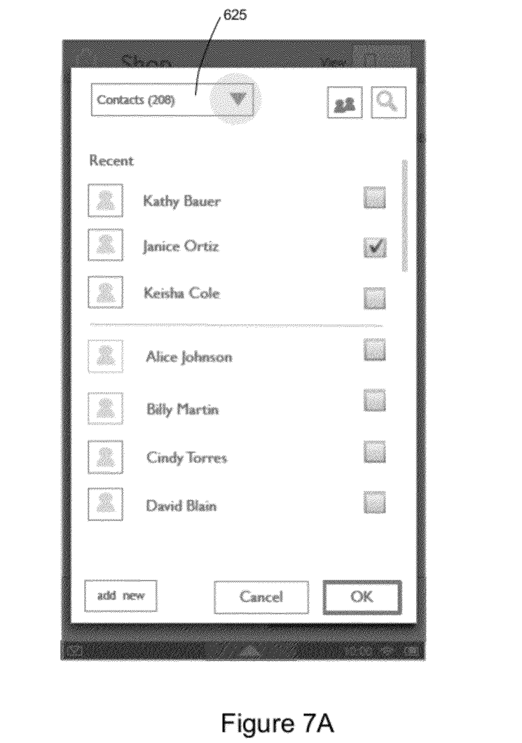

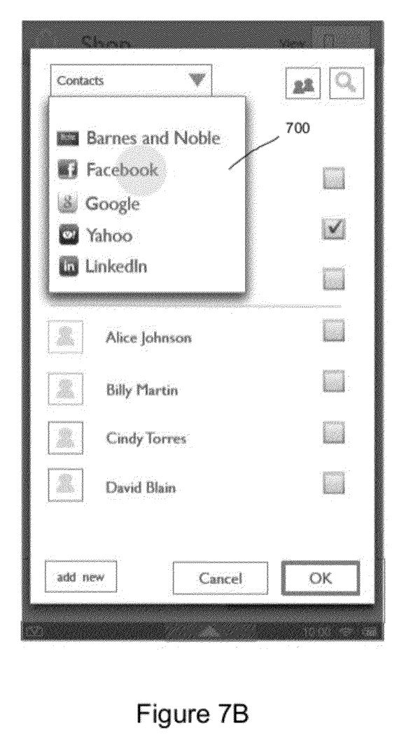

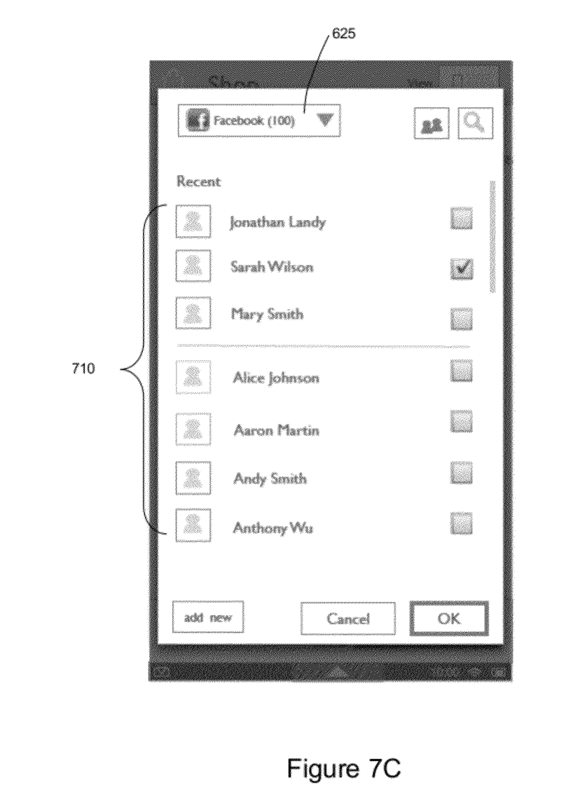

FIGS. 7A-7C depict the (UI) screens illustrating the filtering of a user's contact list by the source of the contact (e.g., from the user's Facebook™ contact list). As shown in FIG. 7A, the user can use filter drop down box 625 to select a filter for particular networks. The network drop down list 700 is illustrated in FIG. 7B. All the networks 25 that the user has configured are shown in this list 700. If the user selects the Facebook™ contact list, all the user's contact that originated from Facebook™ are shown. FIG. 7C illustrates all of the user's contacts 710 that came from Facebook™ after the filter has been applied to the user's contacts.

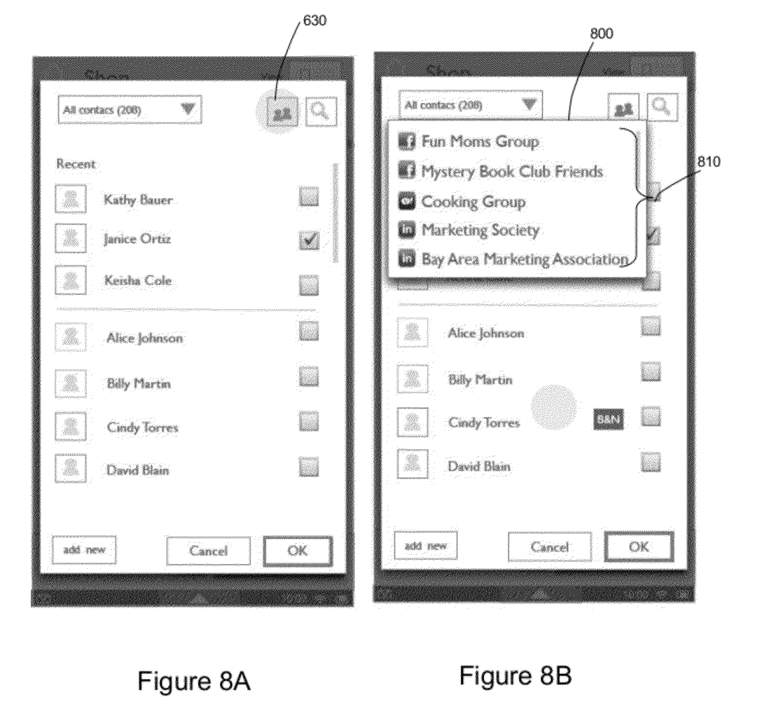

FIGS. 8A-8B depict the (UI) screens illustrating the filtering of a user's contact list by groups. When the user taps on button 630, she is presented with a list box 800 that lists all of the groups 810 that have been created by the user. The user is able to create new groups and associate particular contacts with groups established by the user (e.g., Cooking Club members).

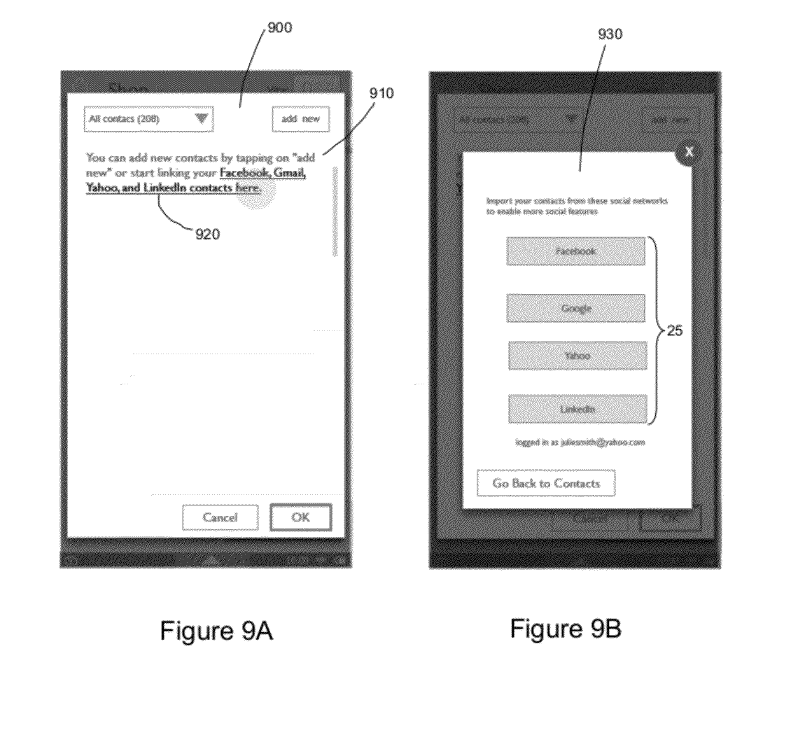

FIGS. 9A-9B depict the (UI) screens illustrating a process of importing a user's contacts from social networks. If the user has no contacts, the hint text 910 in user interface 900 is displayed as seen in FIG. 9A. The underlined part 920 of this hint text is clickable and launches the browser with the accounts settings page 930 as shown in FIG. 9B. On this user interface, all the networks 25 that can be configured for the system are displayed. After the user selects a particular network 25, she is prompted for her credentials (user ID and password) for the particular network 25. After providing the appropriate credential data, the user is taken back to the main contacts application user interface. All the user's credentials for each network 25 are stored in the system in association with the user's account.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

1. A method of generating a composite contact list comprising:
receiving an access token from a user, the access token providing authorized access to at least one network on which the user has a list of contacts;
a server autonomously accessing the at least one network on behalf of the user using the access token;
the server receiving the user's list of contacts from the at least one network; and
the server adding the received list of contacts to the user's existing list of contacts on the server.

2. The method according to claim 1, further comprising:
the server synchronizing the received user's contacts from the at least one network with existing user's contacts on the server.

3. The method according to claim 2, wherein the act of synchronizing further comprises removing duplicate contacts.

4. The method according to claim 1, further comprising:
the server periodically and autonomously:
accessing the at least one network on behalf of the user using the access token,
receiving the user's list of contacts from the at least one network, and
synchronizing the received user's contacts from the at least one network with existing user's contacts on the server.

5. The method according to claim 4, wherein the server periodically and autonomously performs the acts of claim 4 on a schedule.

6. The method according to claim 5, wherein the schedule is predetermined by the user.

7. The method according to claim 1, further comprising:
receiving a plurality of access tokens from the user, each access token providing authorized access to a respective one of a plurality of networks on which the user has respective lists of contacts;
the server autonomously accessing each of the plurality of networks on behalf of the user using the respective access tokens;
the server receiving the user's lists of contacts from each of the plurality of networks; and
the server adding the received lists of contacts to the user's existing list of contacts on the server.

8. The method according to claim 7, further comprising:
the server synchronizing the received user's contacts from the plurality of networks with existing user's contacts on the server.

9. The method according to claim 7, further comprising:
the server periodically and autonomously:
accessing the plurality of networks on behalf of the user using the respective access tokens,
receiving the user's list of contacts from the plurality of networks, and
synchronizing the received user's contacts from the plurality of networks with existing user's contacts on the server.

10. The method according to claim 9, wherein the server periodically and autonomously performs the acts of claim 9 on a schedule.

11. The method according to claim 10, wherein the schedule is predetermined by the user.

12. The method according to claim 7, wherein the plurality of networks include at least one social network.

13. The method according to claim 1, wherein the at least one network is a social network.

14. A system for generating a composite contact list comprising:
a contact list database, the contact list database containing an existing contact list of a user;
a user interface, the user interface communicating with a user device, the user interface receiving an access token from the user, the access token providing authorized access to at least one network on which the user has a list of contacts;
a network interface, the network interface providing an interface to at least one network; and
a contact engine coupled to the contact list database, the user interface and the network interface, the contact engine operable to:
autonomously access the at least one network on behalf of the user using the access token,
receive the user's list of contacts from the at least one network through the network interface, and
add the received list of contacts to the user's existing list of contacts on the contact list database.

15. The system according to claim 14, wherein the contact engine further comprises:
a synchronization engine, the synchronization engine synchronizing the received user's contacts from the at least one network with the existing contact list on the contact list database.

16. The system according to claim 14, wherein the contact list database, the user interface and the contact engine reside on a server remote from the user device.

17. The system according to claim 14, wherein the contact list database, the user interface and the contact engine reside on a plurality of servers remote from the user device.

18. The system according to claim 14, wherein the user interface receives a plurality of access tokens from the user, each access token providing authorized access to a respective one of a plurality of networks on which the user has respective lists of contacts, wherein the network interface provides interfaces to the plurality of networks and wherein the contact engine is further operable to:
access each of the plurality of networks on behalf of the user using the respective access tokens,
receive the user's lists of contacts from each of the plurality of networks, and
add the received lists of contacts to the user's existing list of contacts on the contact list database.

19. The system according to claim 18, further comprising a scheduler coupled to the contact engine, wherein the contact engine periodically performs the acts of claim 18 on a schedule contained in the scheduler.

20. The system according to claim 18, wherein the schedule is predetermined by the user.

21. A method of generating a composite contact list comprising:
receiving a plurality of access tokens from a user, each access token providing authorized access to a respective one of a plurality of networks on which the user has respective lists of contacts;
a server autonomously accessing each of the plurality of networks on behalf of the user using the respective access tokens;
the server receiving the user's lists of contacts from each of the plurality of networks; and
the server adding the received lists of contacts to the user's existing list of contacts on the server.
